(19) United States
(12) Patent Application Publication
(10) Pub. No.: US 2009/0319713 A1
(43) Pub. Date: Dec. 24, 2009

(54) EXPANSION CARD FOR EXTERNAL STORAGE DEVICE

(76) Inventor: Kwok-Yan LEUNG, Willowdale (CA)

Correspondence Address: Muncy, Geissler, Olds & Lowe, PLLC, P.O. BOX 1364, FAIRFAX, VA, 22038-1364, US

(21) Appl. No.: 12/145,221

(22) Filed: Jun. 24, 2008

(51) Int. Cl. G06F 13/00

(52) U.S. Cl. 710/302

(57) ABSTRACT

An expansion card for an external storage device includes a circuit board, and an input power jack, an output power jack, a voltage transforming unit, an input data transmission interface and an output data transmission interface are located on the circuit board. The circuit board includes a plate-like mounting portion which fits into a bus slot of a motherboard such that the expansion card is positioned but not electrically connected to a motherboard bus. During operation, the expansion card receives power from a power supply via the input power jack, transforms the power via the voltage transforming unit, and transmits the power to the external storage device via the output power jack. In addition, the expansion card receives data from a storage device data transmission interface of the motherboard via an input data transmission interface, and transmits the data to the external storage device via an output data transmission interface.

### BACKGROUND OF THE INVENTION

1. Field of the Invention

The present invention relates generally to an expansion card, and more particularly, to an expansion card for an external storage device.

2. The Prior Arts

Typical Standard interfaces for computer external devices include, for example, low speed print port, USB 2.0 having a higher speed, IEEE 1394 having a speed up to 1 Gbps, and ExpressCard having a speed up to 2.5 Gbps.

The most significant difference between USB and IEEE 1394 is that they have different data transmission rate. In the past, many users often chose IEEE 1394 for file transmission because the data transmission rate of IEEE 1394 is one hundred times higher than that of USB 1.1. The USB can only provide a data transmission rate of 12 Mbps so that USB can only be used to interface devices with low data transmission rate, such as, a keyboard, a mouse, a microphone, or the like. The IEEE 1394A, however, can provide a data transmission rate of 400 Mbps so that IEEE 1394A can be used to interface devices with high data transmission rate, such as, a digital camera, a scanner, an information appliance, or the like. Although USB 2.0 interface was developed later, which can provide a data transmission rate similar to IEEE 1394A, the USB 2.0 is still slower than IEEE 1394B and IEEE 1394C that can provide a data transmission rate of 1 Gbps.

ExpressCard is derived from PCMCIA which conventionally transmits data with a PCI architecture (even older 8-bit PCMICA follows ISA specification). The new ExpressCard is instead coupled to the system chipset with PCI Express and USB2.0 architecture. Under the USB2.0 transmission mode, the theoretical transmission rate attainable is 480 Mbps. However, when changed to PCI Express, it can operate in a Daul-Simpex mode such that the transmission rate can reach 2.5 Gbps which is almost the same as the SATA transmission rate. Not only that, the transmission rate may possibly be developed to increase the data transmission rate to 4 Gbps.

Both IEEE1394 and ExpressCard are interfaces that integrate power and data transmission such that the external storage device can be accessed by the host without worrying about the power issue. Even so, it has been unclear whether the IEEE 1394 and ExpressCard can be popularized and widely used by consumers.

In order to provide a high speed and already popularized storage device to a computer host which has a data transmission interface that conventionally does not support an external use (e.g., SATA), it is critically important to consider how to transmit data from the computer host to an external storage device and a voltage attenuation problem.

In some existing systems, such as in Taiwan Patent Publication No. M250212, entitled “Power transforming module”, a voltage transforming concept has been proposed such that the storage device can be provided with an appropriate voltage and can be accessed. However, the system can only support the internal storage device as disclosed and can not support external storage devices.

### SUMMARY OF THE INVENTION

A main objective of the present invention is to provide an expansion card for an external storage device, which can support the external storage device without modifying any original design and configuration of a computer. This is achieved by using a circuit board mountable in a bus slot of a motherboard to transmit power from a power supply and signals from the motherboard to the external storage device.

Accordingly, an expansion card for an external storage device includes a circuit board, and an input power jack, an output power jack, a voltage transforming unit, an input data transmission interface, and an output data transmission interface located on the circuit board. In the expansion card, the circuit board includes a plate-like mounting portion, which fits into a bus slot of the motherboard such that the expansion card can be positioned in the bus slot but not electrically connected to a bus of the motherboard. During operation, the expansion card receives power from the power supply via the input power jack, transforms the power via the voltage transforming unit, and transmits the power to the external storage device via the output power jack. In addition, the expansion card receives data from the storage device data transmission interface of the motherboard via an input data transmission interface, and transmits the data to the external storage device via the output data transmission interface.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view of an expansion card for an external storage device in accordance with the present invention; and

FIG. 2 is a schematic view showing the expansion card for the external storage device in a using state.

### DETAILED DESCRIPTION OF THE PREFERRED EMBODIMENT

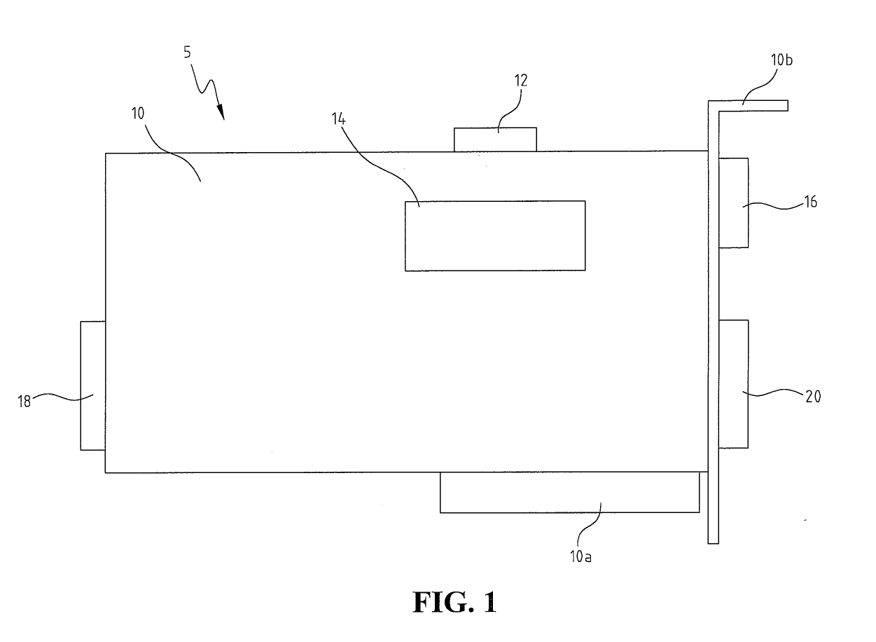

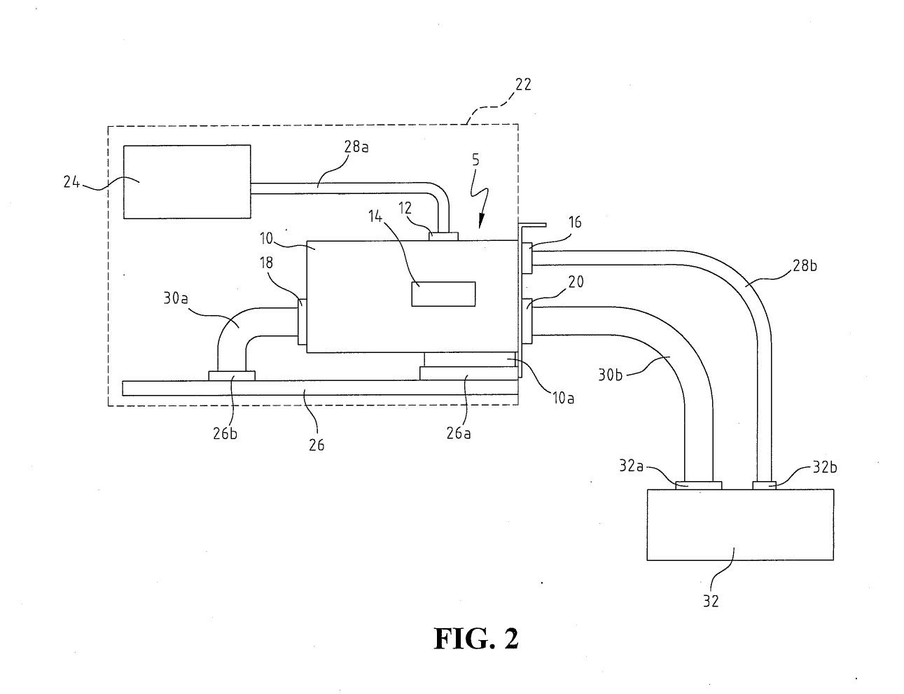

Referring to FIG. 1, an expansion card 5 for an external storage device in accordance with one embodiment of the present invention mainly includes a circuit board 10, and an input power jack 12, an output power jack 16, a voltage transforming unit 14, an input data transmission interface 18 and an output data transmission interface 20 that are located on the circuit board 10. The circuit board 10 further includes a plate-like mounting portion 10a positioned at an edge of the circuit board 10. The plate-like mounting portion 10a has a thickness and a size configured to fit into a bus slot 26a of a motherboard 26 (as shown in FIG. 2).

In brief, in order to secure the expansion card 5 of the present invention to a computer chassis 22 without modifying the original design of the computer chassis 22 and the motherboard 26, the expansion card 5 of the present invention includes the plate-like mounting portion 10a and optionally an inverted L-shaped mounting bracket 10b as in ordinary expansion cards (e.g., video cards), which are used to mount the expansion card 5 to a computer chassis 22. However, the plate-like mounting portion 10a of the present invention includes no conducting terminals for electrical connection and only serves as an element mechanically mounted in the bus slot. Besides, with the provision of the jacks and the interfaces (i.e., the input power jack 12, the input data transmission interface 18), the expansion card 5 of the present invention not only can receive power from a power supply 24 (as shown in FIG. 2) and receive signals from the motherboard 26, but also can transmit the power and signals to an external storage device 32 to thereby provide the support to the external storage device. A detail description is made below to discuss how to implement these functions.

Referring to FIG. 2, the motherboard 26 and the power supply 24 are received in the computer chassis 22. In the illustrated embodiment, the power supply 24 can supply power of 12V/5V. The motherboard 26 includes at least the bus slot 26a and a storage device data transmission interface 26b. The external storage device 32 is equipped with at least a power input terminal 32b and a data input terminal 32a. In various embodiments of the present invention, the bus slot 26a can be of AGP, PCI Express, PCI, ISA, EISA, or LPC type. The storage device data transmission interface 26b can be small computer system interface (SCSI), fibre channel interface (FC), serial storage architecture (SSA), integrated drive electronics (IDE), personal computer memory card international association (PCMCIA) interface, serial ATA (SATA), or parallel ATA (PATA).

To install the expansion card 5 of the present invention, the plate-like mounting portion 10a is aligned with and then inserted into the bus slot 26a of the motherboard 26, with a screw hole (not shown) of the L-shaped mounting bracket 10b being aligned with a screw hole of the computer chassis 22. The expansion card 5 is then secured to the computer chassis 22 via a screw engaged in the screw holes. After the expansion card 5 is installed, the next step is to plug all necessary cables.

In plugging power cables, as shown in FIG. 2, a first power cable 28a is used to electrically connect the power supply 24 to the input power jack 12, and a second power cable 28b is used to electrically connect the power input terminal 32b of the external storage device 32 to the output power jack 16. In plugging data cables, a first transmission cable 30a is used to electrically connect the storage device data transmission interface 26b of the motherboard 26 to the input data transmission interface 18, and a second transmission cable 30b is used to electrically connect the data input terminal 32a of the external storage device 32 to the output data transmission interface 20. In the illustrated embodiment, the input data transmission interface 18 is directly electrically connected to the output data transmission interface 20, while the input power jack 12 is indirectly electrically connected to the output power jack 16 via the voltage transforming unit 14. Once the cables are properly plugged, the expansion card 5 is available for operation.

During operation, the expansion card 5 of the present invention receives power from the power supply 24 via the input power jack 12, transforms the power via the voltage transforming unit 14, and transmits the power to the external storage device 32 via the output power jack 16. In addition, the expansion card 5 receives data from the storage device data transmission interface 26b of the motherboard 26, and transmits the data to the external storage device 32 via the output data transmission interface 20.

During operation, the voltage transforming unit 14 can increase or decrease the voltage inputted from the input power jack 12 according to a power demand of the external storage device 32, and then the transformed power is outputted to the external storage device 32 via the output power jack 16. For example, long distance power transmission through the first power cable 28a can easily cause voltage loss or voltage attenuation. Therefore, considering the voltage loss, the voltage needs to be slightly increased in advance such that the actual voltage transmitted to the external storage device 32 is sufficient to start the external storage device 32. In other words, assuming the length of the first power cable 28a is 3 meters, such a length could cause a voltage drop of 0.6V (resistance is 0.2 ohm). As a result, the voltage transmission unit 14 needs to increase the voltage from the input power jack 12 by 0.6V before the voltage is outputted to the external storage device 32 via the output power jack 16.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An expansion card for an external storage device, the expansion card being configured to provide power and access to the external storage device and to be mounted in a bus slot of a motherboard within a computer chassis, the motherboard comprising at least one storage device data transmission interface, the compute chassis comprising at least one power supply, the expansion card comprising:
a circuit board comprising a plate-like mounting portion, the mounting portion having a thickness and a size configured to fit into the bus slot of the motherboard;
an input power jack located on the circuit board and electrically connected to the power supply of the computer chassis via a first power cable;
an output power jack located on the circuit board and electrically connected to a power input terminal of the external storage device via a second power cable;
a voltage transforming unit located on the circuit board and electrically connected between the input power jack and the output power jack, the voltage transforming unit being configured to increase or decrease the voltage inputted from the input power jack according to a power demand of the external storage device, and output the transformed power to the external storage device via the output power jack;
an input data transmission interface located on the circuit board and electrically connected to the storage device data transmission interface of the motherboard via a first transmission cable; and
an output data transmission interface located on the circuit board and electrically connected to a data input terminal of the external storage device via a second transmission cable.

2. The expansion card as claimed in claim 1, wherein the plate-like mounting portion comprises no conducting terminals such that the circuit board is coupled to the motherboard via the bus slot in a non-electrically conductive manner.

3. The expansion card as claimed in claim 1, wherein the power supply provides power of 12V/5V.

4. The expansion card as claimed in claim 1, wherein the expansion card comprises an inverted L-shaped mounting bracket with a screw hole defined therethrough, and the screw hole is aligned with a screw hole of the computer chassis when the expansion card is mounted in the bus slot.
